(19) United States
(12) Patent Application Publication
(10) Pub. No.: US 2026/0330844 A1
(43) Pub. Date: Oct. 22, 2026

(54) MOVEMENT ASSISTANCE SYSTEM, MOVEMENT ASSISTANCE METHOD, AND NON-TRANSITORY COMPUTER-READABLE RECORDING MEDIUM

(71) Applicant: TOYOTA JIDOSHA KABUSHIKI KAISHA, Aichi-ken (JP)

(72) Inventor: Yusuke FUKUI, Miyoshi-shi (JP)

(21) Appl. No.: 19/641,524

(22) Filed: Apr. 8, 2026

(30) Foreign Application Priority Data
Apr. 17, 2025 (JP) 2025-068192

(51) Int. Cl. G06V 20/58; B60W 30/09; G06T 11/00; G06V 20/54; G06V 40/10; G08G 1/16

(52) U.S. Cl. CPC G06V 20/58; B60W 30/09; G06T 11/00; G06V 20/54; G08G 1/16; B60W 2420/403; G06V 40/10; G06V 2201/07

(57) ABSTRACT

A movement assistance system acquires first object information and image information using a first sensor equipped with a moving body, and acquires second object information using a second sensor of an external system. When detecting a target object based on the second object information, the system generates a virtual space image that represents the result of prediction of the state of the target object based on the second object information, acquires a real space image based on the image information acquired at a timing synchronized with time of the virtual space image, inputs, to a multimodal generative AI model, input information including the virtual space image, the real space image, and a prompt that instructs an output of output information indicating the result of determination as to whether the target object is present in the real space image, and causes the model to output the output information.

### CROSS-REFERENCES TO RELATED APPLICATION

The present disclosure claims priority under 35 U.S.C. § 119 to Japanese Patent Application No. 2025-068192, filed on Apr. 17, 2025, which is incorporated herein by reference in its entirety.

### BACKGROUND

### Technical Field

The present disclosure relates to a technique for assisting the movement of a moving body.

### Background Art

JP 2020-177314 A discloses a vehicle traffic management device. The vehicle traffic management device generates prediction information indicating predicted positions of other vehicles/pedestrians based on measurement information from a plurality of roadside devices, and transmits the generated prediction information to a target vehicle. An in-vehicle device of the target vehicle compares the predicted positions of other vehicles/pedestrians indicated by the prediction information from the vehicle traffic management device, with the actual positions of the other vehicles/pedestrians based on measurement information from an in-vehicle sensor, and evaluates the prediction information based on the comparison results.

Moreover, JP H11-139229 A discloses a traveling environment monitoring alarm device that predicts the movement of an obstacle detected by a laser radar device and outputs an alarm sound at an alarm level depending on whether or not a driver is aware of the obstacle.

### SUMMARY

There is a movement assistance system that acquires first object information around a moving body by using one or more first sensors equipped with the moving body in order to assist the movement of the moving body. In this movement assistance system, utilizing second object information around the moving body acquired by one or more second sensors included in an external system that communicates wirelessly with the moving body is beneficial because this makes it possible to acquire information on objects that are not detected by the one or more first sensors. Further, it is desirable to be able to appropriately recognize a target object that is not detected by the one or more first sensors but is detected by the one or more second sensors.

The present disclosure has been made in view of the problem described above, and an object thereof is to provide a technique that enables more appropriate recognition of a target object present around a moving body.

A movement assistance system according to the present disclosure assists the movement of a moving body, and includes one or more first sensors, one or more second sensors, and one or more processors. The one or more first sensors are equipped with the moving body. The one or more second sensors are included in one or more external systems that perform wireless communication with the moving body. The one or more processors are configured to: acquire first object information and image information around the moving body using the one or more first sensors; acquire second object information around the moving body using the one or more second sensors; and when detecting a target object based on the second object information, execute virtual image generation processing, real image acquisition processing, and target object determination processing. The virtual image generation processing includes generating a virtual space image that represents the result of prediction of the state of the target object, based on the second object information. The real image acquisition processing includes acquiring a real space image that is based on the image information acquired at a timing synchronized with time of the virtual space image. The target object determination processing includes: inputting, to a multimodal generative AI model, input information including the virtual space image, the real space image, and a prompt that instructs an output of output information indicating the result of determination as to whether or not the target object is present in the real space image; and causing the multimodal generative AI model to output the output information.

A movement assistance method according to the present disclosure is executed by a computer to assist the movement of a moving body. The movement assistance method includes: acquiring first object information and image information around the moving body using one or more first sensors equipped with the moving body; acquiring second object information around the moving body using one or more second sensors included in one or more external systems that perform wireless communication with the moving body; and when detecting a target object based on the second object information, executing virtual image generation processing, real image acquisition processing, and target object determination processing. The virtual image generation processing includes generating a virtual space image that represents the result of prediction of the state of the target object, based on the second object information. The real image acquisition processing includes acquiring a real space image that is based on the image information acquired at a timing synchronized with time of the virtual space image. The target object determination processing includes: inputting, to a multimodal generative AI model, input information including the virtual space image, the real space image, and a prompt that instructs an output of output information indicating the result of determination as to whether or not the target object is present in the real space image; and causing the multimodal generative AI model to output the output information.

A non-transitory computer-readable recording medium according to the present disclosure stores a movement assistance program executed by a computer to assist the movement of a moving body. The movement assistance program causes the computer to execute: acquiring first object information and image information around the moving body using one or more first sensors equipped with the moving body; acquiring second object information around the moving body using one or more second sensors included in one or more external systems that perform wireless communication with the moving body; and when detecting a target object based on the second object information, executing virtual image generation processing, real image acquisition processing, and target object determination processing. The virtual image generation processing includes generating a virtual space image that represents the result of prediction of the state of the target object, based on the second object information. The real image acquisition processing includes acquiring a real space image that is based on the image information acquired at a timing synchronized with time of the virtual space image. The target object determination processing includes: inputting, to a multimodal generative AI model, input information including the virtual space image, the real space image, and a prompt that instructs an output of output information indicating the result of determination as to whether or not the target object is present in the real space image; and causing the multimodal generative AI model to output the output information.

According to the present disclosure, when a target object is detected based on the second object information, the virtual image generation processing, the real image acquisition processing, and the target object determination processing are executed. This makes it possible to appropriately recognize the target object that is not detected by the first sensor but is detected by the second sensor.

### BRIEF DESCRIPTION OF THE DRAWINGS

FIG. 1 is a schematic diagram showing an example of a configuration of a travel assistance system according to an embodiment;

FIG. 2 is a flowchart showing an example of flow of processing related to travel assistance according to an embodiment;

FIG. 3 shows an example of a virtual space image according to an embodiment;

FIG. 4 shows an example of a real space image according to an embodiment; and

FIG. 5 is a flowchart showing another example of flow of processing related to the travel assistance according to an embodiment.

### DETAILED DESCRIPTION

Embodiments of the present disclosure will be described with reference to the accompanying drawings.

A “movement assistance system” according to the present disclosure is a system that assists the movement of a moving body. Examples of the moving body include a vehicle (e.g., an automobile), an aircraft, and a robot (e.g., a logistics robot). In the following description, a movement assistance system (i.e., a travel assistance system) applied to a vehicle, which is an example of the moving body, will be considered as an example. When generalizing, the term “vehicle” in the following description should be read as “moving body”.

### 1. Configuration of Travel Assistance System

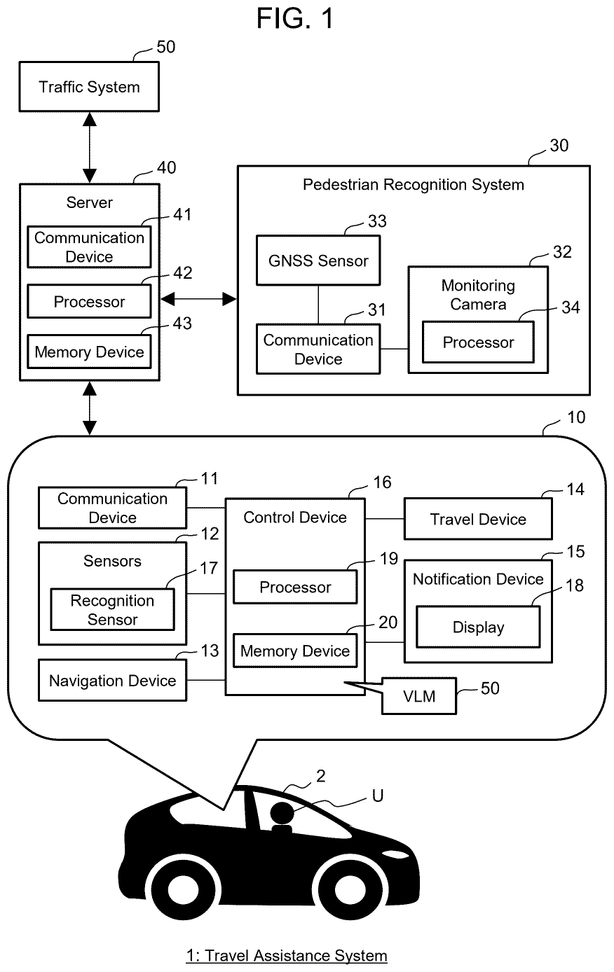

FIG. 1 is a schematic diagram showing an example of the configuration of a travel assistance system 1 according to the present embodiment. The travel assistance system 1 according to the present embodiment is a system that assists the travel of a vehicle 2. The travel assistance system 1 includes, for example, an in-vehicle system 10, a pedestrian recognition system 30, and a server 40.

In one example, the vehicle 2 is a vehicle operated (driven) by a user U. The travel assistance system 1 is a system that assists the travel of the vehicle 2 by, for example, assisting the user U in driving the vehicle 2. However, the vehicle to which the travel assistance system 1 is applied may be an automated driving vehicle. Furthermore, the user U is, for example, a driver who gets into the vehicle 2 and drives the vehicle 2, but may also remotely operate the vehicle 2 from outside the vehicle 2 using a remote operation device.

The in-vehicle system 10 includes a communication device 11, sensors 12, a navigation device 13, a travel device 14, a notification device 15, and a control device 16.

The communication device 11 performs wireless communication with the outside of the vehicle 2. For example, the communication device 11 performs wireless communication with the pedestrian recognition system 30 via the server 40. The communication device 11 also performs wireless communication with a traffic system 50 via the server 40. The traffic system 50 generates traffic situation information TS that indicates the traffic situations of roads within an area in which the vehicle 2 travels, and transmits the traffic situation information TS to an external device or system, such as the server 40. Examples of the traffic situation information TS include traffic congestion information, traffic control information, and traffic light display information. Alternatively, the communication device 11 may directly communicate wirelessly with each of the pedestrian recognition system 30 and the traffic system 50.

The sensors 12 are equipped with the vehicle 2 and include, for example, a recognition sensor 17, a vehicle state sensor, and a position sensor. The recognition sensor 17 recognizes (detects) the surrounding situation of the vehicle 2. Examples of the recognition sensor 17 include a camera, a LIDAR (Laser Imaging Detection and Ranging), a radar, and a sonar. The camera includes at least a front camera that captures an image of the situation ahead of the vehicle 2. The vehicle state sensor detects the state of the vehicle 2 (for example, vehicle speed, yaw rate, acceleration, steering angle). The position sensor detects the position and orientation of the vehicle 2. For example, the position sensor includes a Global Navigation Satellite System (GNSS) sensor.

The navigation device 13 generates a planned travel route R (planned movement route) for the vehicle 2 based on, for example, information from the sensors 12 and the traffic system 50 as well as destination information received from the user U. The travel device 14 includes a drive device, a steering device, and a brake device. The drive device includes one or both of an electric motor and an internal combustion engine for driving the vehicle 2. The steering device includes an electric motor that steers the wheels. The brake device includes a brake actuator for braking the vehicle 2. In addition, the travel device 14 corresponds to one or more actuators for traveling (moving) the vehicle 2 (moving body).

The notification device 15 notifies the user U of information. The notification device 15 includes a display 18. The display 18 is, for example, a head-up display (HUD) that displays information on the front windshield of the vehicle 2, or a display installed on the instrument panel. The notification device 15 may include a speaker for notifying the user U by voice or sound. The notification device 15 may include a vibration device for notifying the user U through the sense of touch. The vibration device may be attached to the steering wheel, for example.

The control device 16 controls the vehicle 2. The control device 16 includes one or more processors 19 (hereinafter, simply referred to as a processor 19) and one or more memory devices 20 (hereinafter, simply referred to as a memory device 20). The processor 19 executes various kinds of processing including those related to travel assistance TA described below. Examples of the processor 19 include a general purpose processor, a specific purpose processor, a central processing unit (CPU), a graphics processing unit (GPU), an application specific integrated circuit (ASIC), and a field-programmable gate array (FPGA). The processor 19 may also be referred to as processing circuitry. Examples of the memory device 20 include a volatile memory, a non-volatile memory, a hard disk drive (HDD), and a solid state drive (SSD). The functions of the control device 16 may be realized by cooperation between the processor 19 that executes a computer program and the memory device 20. The computer program is stored in the memory device 20. Alternatively, the computer program may be recorded in a non-transitory computer-readable recording medium or provided via a network.

The memory device 20 stores various kinds of information necessary for the various kinds of processing. The various kinds of information includes a map database. The processor 19 acquires map information M of the required area from the map database. The map information M includes a general navigation map. The map information M may also indicate lane layout and road shapes. The map information M may include location information on, for example, structures, traffic lights, and signs. The map database may be stored in an external system, such as the server 40.

The various kinds of information stored in the memory device 20 also includes various kinds of sensor information SEN detected by the sensors 12. The sensor information SEN includes surrounding situation information SUR based on the recognition sensor 17, vehicle state information STA based on the vehicle state sensor described above, and position information POS1 based on the position sensor described above.

To be more specific, the surrounding situation information SUR includes first object information TO1 related to objects around the vehicle 2, and image information I related to images IMG1 of the surroundings of the vehicle 2 captured by the camera described above. The surrounding situation information SUR may include point cloud information measured by the LIDAR. The image information I may be acquired using the LIDAR. Examples of recognized objects include pedestrians, bicycles, motorcycles, other vehicles (e.g., preceding vehicles, following vehicles, oncoming vehicles, parked vehicles,), white lines, stop lines, traffic lights, structures (e.g., curbs, guardrails, utility poles, pedestrian bridges), signs, and obstacles.

The first object information TO1 indicates, for example, the relative position of the object with respect to the vehicle 2. The first object information TO1 may indicate the relative speed of the object with respect to the vehicle 2. The first object information TO1 may indicate the type of the object. The first object information TO1 may indicate the posture of the object. For example, by analyzing the image IMG1 acquired by the camera, the processor 19 can identify an object and calculate the relative position of the object. Further, by using an object detection model based on machine learning, the processor 19 can detect an object appearing in the image IMG1 and recognize the type of the object. Further, by using a posture estimation model based on machine learning, the processor 19 can estimate the posture of an object appearing in the image IMG1. Furthermore, based on the point cloud information acquired by the LIDAR, the processor 19 can identify an object and acquire the relative position and relative speed of the object. The first object information TO1 may include trajectory information acquired by tracking the recognized object. In addition, the recognition sensor 17 corresponds to an example of the “one or more first sensors” according to the present disclosure.

For example, a plurality of pedestrian recognition systems 30 are installed in an area where the vehicle 2 travels. Each of the pedestrian recognition systems 30 includes a communication device 31, a monitoring camera 32, and a GNSS sensor 33. The communication device 31 performs wireless communication with the server 40. The monitoring camera 32 is installed so as to capture images of the road on which the vehicle 2 is traveling and the surroundings of the road. More specifically, for example, the monitoring camera 32 captures images of a crosswalk that intersects with the road on which the vehicle 2 is traveling and the surroundings of the crosswalk.

The monitoring camera 32 includes a processor 34. The processor 34 analyzes an image IMG2 acquired by the monitoring camera 32 to recognize an object included in the image IMG2 and acquire object information on the object. When the vehicle 2 is traveling in the vicinity of the monitoring camera 32, this object information corresponds to “object information in the vicinity of the vehicle 2 (hereinafter, referred to as second object information TO2)”. Therefore, the monitoring camera 32 corresponds to an example of the “one or more second sensors” according to the present disclosure. The content of the second object information TO2 is the same as the content of the first object information TO1 described above. However, the relative position and relative speed of the object in the second object information TO2 are relative to the monitoring camera 32.

The GNSS sensor 33 is used to acquire position information POS2 of the monitoring camera 32. The processor 34 can identify the position of the object based on the position information POS2. The communication device 31 transmits the object information (including the second object information TO2) acquired using the monitoring camera 32 to the server 40 together with the position information POS2. In addition, the pedestrian recognition system 30 may include a memory device that stores the acquired object information (including the second object information TO2).

The server 40 is, for example, a cloud server, and includes a communication device 41, one or more processors 42 (hereinafter, simply referred to as a processor 42), and one or more memory devices 43 (hereinafter, simply referred to as a memory device 43). The communication device 41 performs wireless communication with each of the vehicle 2, the pedestrian recognition system 30, and the traffic system 50. The processor 42 executes various kinds of processing. The processor 42 may also be referred to as processing circuitry. Examples of the processor 42 include a general purpose processor, a special purpose processor, a CPU, a GPU, an ASIC, and an FPGA. The memory device 43 stores various kinds of information necessary for the various kinds of processing. Examples of the memory device 43 include a volatile memory, a non-volatile memory, an HDD, and an SSD. The functions of the server 40 may be realized by cooperation between the processor 42 that executes a computer program and the memory device 43. The computer program is stored in the memory device 43. Alternatively, the computer program may be recorded in a non-transitory computer-readable recording medium or provided via a network.

The server 40 manages various kinds of information used in the travel assistance system 1. Specifically, the server 40 stores the object information (including the second object information TO2) received from each of the pedestrian recognition systems 30 in the memory device 43 together with the position information POS2. The server 40 receives the traffic situation information TS for each location on the planned travel route R of the vehicle 2 from the traffic system 50 and stores the received traffic situation information TS in the memory device 43. The server 40 receives various kinds of information (e.g., the position information POS1, the planned travel route R, the first object information TO1, the image information I) from the in-vehicle system 10 and stores the received various kinds of information in the memory device 43. Based on the position information POS1 on the vehicle 2 and the position information POS2 on each monitoring camera 32, the server 40 (processor 42) can acquire the object information from the pedestrian recognition system 30 located in the vicinity of the vehicle 2, i.e., the second object information TO2 related to an object in the vicinity of the vehicle 2.

The travel assistance system 1 according to the present embodiment uses a large-scale vision-language model (VLM) 50 (see FIG. 1) for “travel assistance TA” described below. The VLM 50 is a generative AI model that processes visual information (images or videos) and text information (language data) in an integrated manner. Examples of the VLM 50 include GPT-4, Gemini, CLIP, and DALL-E. In the configuration example shown in FIG. 1, the control device 16 of the in-vehicle system 10 includes the VLM 50. Alternatively, the server 40 may include the VLM 50, or another external system included in the travel assistance system 1 may include the VLM 50. In addition, the VLM 50 corresponds to an example of the “multimodal generative AI model” according to the present disclosure.

Additionally, in the configuration example shown in FIG. 1, the pedestrian recognition system 30 corresponds to an example of the “one or more external systems” according to the present disclosure. Another example of the “one or more external systems” is an in-vehicle system installed in another vehicle (another moving body) traveling around the vehicle 2. That is, the second object information TO2 may be acquired using, for example, a recognition sensor (one or more second sensors) included in the in-vehicle system of the another vehicle. In yet another example, the travel assistance system 1 may not include the server 40 but may include an in-vehicle system configured to have the functions of the server 40.

### 2. Travel Assistance (Movement Assistance)

The travel assistance provided by the travel assistance system 1 includes travel assistance TA that assists the travel of the vehicle 2 based on information about objects present around the vehicle 2. Examples of objects that are targets of the travel assistance TA (i.e., target objects X) include moving targets, such as pedestrians, bicycles, motorcycles, and other vehicles. The following description will be given using a pedestrian recognized by the pedestrian recognition system 30 as an example of the target object X. Further, the following description will be given taking travel assistance TA for assisting the user U in driving the vehicle 2, for example. However, the travel assistance TA may also be assistance in autonomous traveling, which is provided for an automated driving vehicle.

In the travel assistance TA, utilizing the second object information TO2 acquired using the monitoring camera 32 (second sensor) included in the pedestrian recognition system 30 (external system) together with the first object information TO1 acquired using the recognition sensor 17 (first sensor) equipped with the vehicle 2 is beneficial because this makes it possible to acquire information on objects that are not detected by the recognition sensor 17. Further, it is desirable to be able to appropriately determine (recognize) a target object X that is not detected by the recognition sensor 17 but is detected by the monitoring camera 32.

Accordingly, in the present embodiment, when detecting a target object X based on the second object information TO2, the travel assistance system 1 executes “virtual image generation processing”, “real image acquisition processing”, and “target object determination processing” as follows.

The virtual image generation processing includes generating a virtual space image VSI based on the second object information TO2. The virtual space image VSI represents the result of a prediction of the state of the target object X. The “state of the target object X” mentioned here refers to, for example, the state of movement or behavior of the target object X.

The real image acquisition processing includes acquiring a real space image RSI that is based on the image information I acquired at a timing synchronized with time t of the virtual space image VSI. The time t is the point in time (i.e., future time) at which the state of the target object X is predicted. In other words, the time t is the target point in time for predicting the state of the target object X. Therefore, the image information I when the time t actually arrives corresponds to the image information I acquired in the real image acquisition processing.

The target object determination processing includes inputting input information MI, which includes the acquired virtual space image VSI and real space image RSI and a prompt PT, to the VLM 50 and causing the VLM 50 to output output information MO. The prompt PT is an instruction to the VLM 50 to output the output information MO. The output information MO is information indicating the result of determination as to whether or not the target object X is present in the real space image RSI (in other words, whether or not the target object X can be detected by the recognition sensor 17 (first sensor)).

### 2-1. Example of Processing Flow

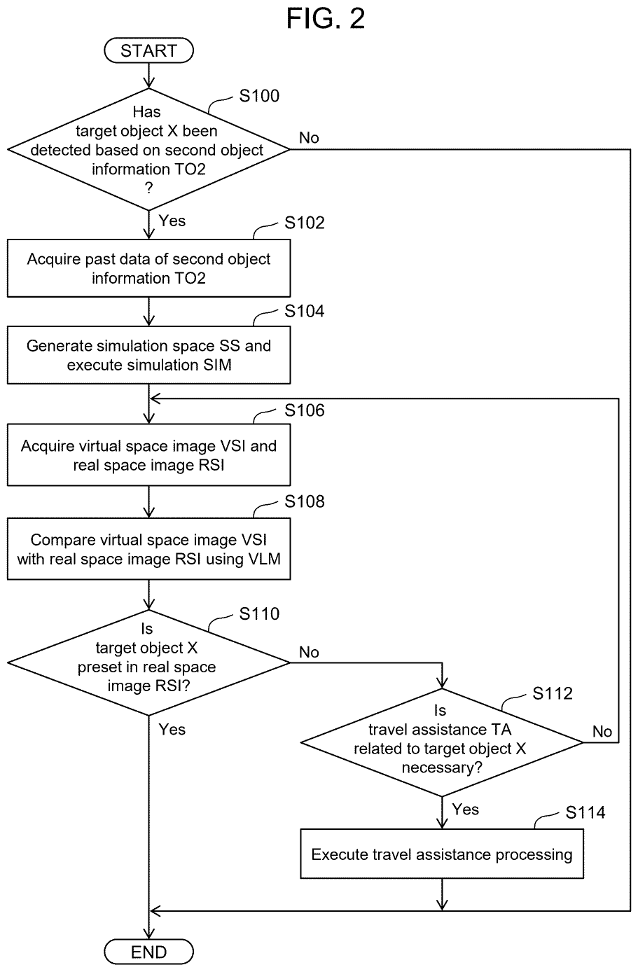

FIG. 2 is a flowchart showing an example of the flow of processing related to the travel assistance TA according to the present embodiment. The processing of this flowchart is executed by, for example, the processor 19 of the in-vehicle system 10.

In step S100, the processor 19 determines whether or not a target object X has been detected, based on the second object information TO2. Specifically, for example, the in-vehicle system 10 transmits the position information POS1 of the vehicle 2 to the server 40, and acquires the second object information TO2 corresponding to the position information POS1 from the server 40 at predetermined intervals. The acquired second object information TO2 may be stored in the memory device 20. The processor 19 determines whether or not the target object X (pedestrian) is present in the vicinity of the vehicle 2, based on the acquired second object information TO2. As a result, when the target object X is not detected (step S100: No), the processing proceeds to END. On the other hand, when the target object X is detected (step S100: Yes), the processing proceeds to step S102.

In step S102, the processor 19 acquires past data of the second object information TO2 related to the detected target object X. The past data is acquired from the memory device 20 of the vehicle 2 or the server 40. Thereafter, the processing proceeds to step S104.

In step S104, the processor 19 generates (constructs) a simulation space SS. The simulation space SS is a three-dimensional virtual space (cyberspace) in which a simulation SIM is performed to predict the state of a target object X (e.g., the state of movement or behavior of a pedestrian) detected around the vehicle 2. The processor 19 generates the simulation space SS based on the second object information TO2. For example, the processor 19 generates the simulation space SS by utilizing an existing technique for generating three-dimensional models to reconstruct, based on the second object information TO2, the three-dimensional environment around the vehicle 2 in which the target object X is present. In addition, the processor 19 may generate the simulation space SS based on, for example, at least one of information on the image IMG2 captured by the monitoring camera 32 and the map information M, together with the second object information TO2.

The processor 19 executes the simulation SIM using the generated simulation space SS. The simulation SIM is executed for a target period of the above-described prediction (i.e., a prediction target period P). The prediction target period P is a future period with respect to the time when the target object X is detected, and corresponds to the period during which the vehicle 2 traveling (moving) along the planned travel route R approaches the target object X. The predicted target period P is determined (calculated) based on, for example, the position information on the target object X included in the second object information TO2, the position information POS1 and speed information of the vehicle 2 included in the sensor information SEN, and the planned travel route R. More specifically, for example, the processor 19 executes the simulation SIM at each of a plurality of times ti (i=1 to n) that arrive in order at each predetermined time T during the prediction target period P (i.e., in chronological order). The processor 19 stores, in the memory device 20, three-dimensional model data MD, which is information indicating the result of the simulation SIM in the simulation space SS (i.e., the result of the above-described prediction).

Based on the past data related to the target object X, the processor 19 executes the simulation SIM, for example, as follows. That is, the simulation SIM is executed to predict, for example, the movement path of the target object X (e.g., the path of a pedestrian) based on the position history of the target object X. In another example, past data regarding the facial direction of a pedestrian (target object X) may be used to predict the path of the pedestrian. Furthermore, the simulation SIM may be executed while making a predictive determination as to whether or not the vehicle 2 traveling along the planned travel route R is likely to come into contact with the target object X (e.g., a pedestrian). If a determination result indicating that the risk of the contact has disappeared is obtained at one of the times ti (for convenience, referred to as “time tz”), the simulation SIM may be executed to end at the time tz. By executing the simulation SIM in this manner, the processor 19 acquires the result of the prediction of the state of the target object X at each time ti. In addition, the simulation SIM does not necessarily have to be performed for a plurality of times ti during the prediction target period P, but may be performed for only one time t1.

Furthermore, the processor 19 may execute the simulation SIM based not only on the second object information TO2 but also on the traffic situation information TS indicating the traffic situation around the detected target object X. The traffic situation information TS is acquired from the traffic system 50 via the server 40. For example, the traffic light display information (traffic situation information TS) on a pedestrian traffic light installed at a crosswalk around a pedestrian may be used to predict the state of the target object X (e.g., the path of the pedestrian) in the simulation SIM.

After step S104, the processing proceeds to step S106. When the time t1 in the prediction target period P arrives, the processor 19 executes the processing of step S106. Thereafter, if the processing returns to step S106 due to the determination result in step S112 described below becoming No, the processor 19 executes the processing of step S106 again when the time t2 arrives. The same applies below. In other words, if the determination result in step S112 is repeatedly No, the processing of step S106 (and S108-S112) may be executed a maximum of n times.

In step S106, the processor 19 acquires a virtual space image VSI and a real space image RSI.

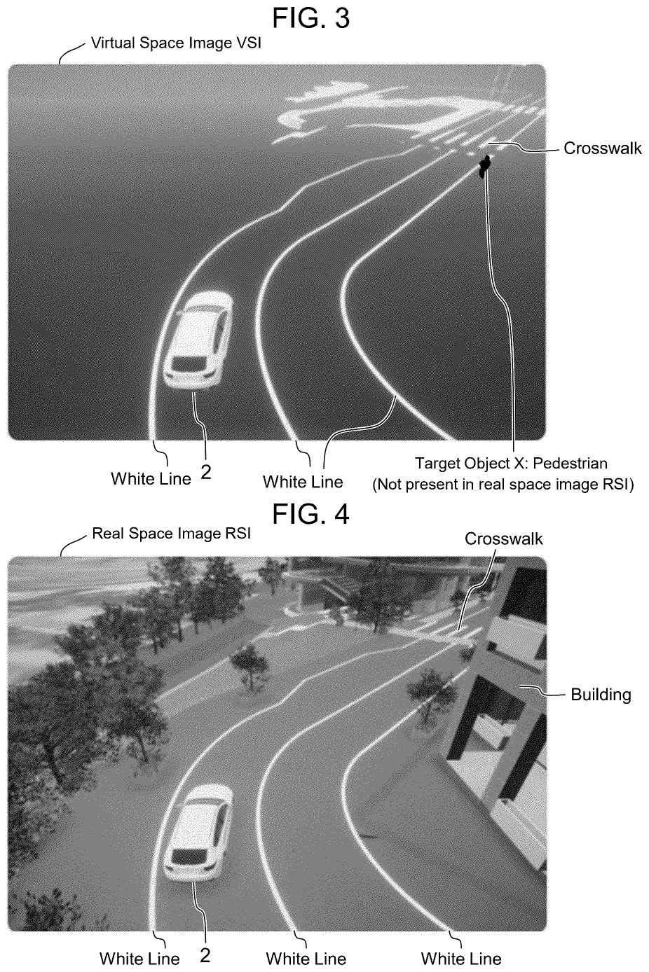

First, the virtual space image VSI is an image acquired in the simulation space SS. Therefore, the virtual space image VSI represents the result of the prediction of the state of the target object X at the time ti during the prediction target period P. The processor 19 acquires the three-dimensional model data MD at the current time ti from the memory device 20. Then, the processor 19 generates a virtual space image VSI from the acquired three-dimensional model data MD using, for example, an existing rendering technique. For example, the virtual space image VSI may be generated as a bird's-eye view image of the vehicle 2 and its surroundings viewed from above. FIG. 3 shows an example of the virtual space image VSI generated in this manner. In addition, the processing of generating the virtual space image VSI in step S106 corresponds to an example of the “virtual image generation processing”.

On the other hand, the real space image RSI is based on the image information I acquired using the recognition sensor 17 equipped with the vehicle 2. In step S106, the processor 19 acquires the image information I at the time ti when the processing of step S106 is currently executed. That is, the image information I is acquired at a timing synchronized with the time ti of the virtual space image VSI generated in step S106 this time.

The real space image RSI is acquired, for example, as follows. That is, for example, the processor 19 may use an existing viewpoint conversion technique to generate a real space image RSI from a plurality of images including the image IMG1 included in the image information I such that the real space image RSI is an image from the same viewpoint as the virtual space image VSI. FIG. 4 shows an example (bird's-eye view image) of the real space image RSI generated in this manner. Alternatively, for example, the real space image RSI may be the image IMG1 itself included in the image information I (i.e., the image captured from the viewpoint of the recognition sensor 17 equipped with the vehicle 2). In an example in which the real space image RSI is the image IMG1 itself, the virtual space image VSI may be generated so as to be an image from the same viewpoint as the image IMG1. In addition, the processing related to the acquisition of the real space image RSI in step S106 corresponds to an example of the “real image acquisition processing”.

In step S108 subsequent to step S106, the processor 19 compares the acquired virtual space image VSI with the real space image RSI using the VLM 50. Specifically, the processor 19 generates a prompt PT that instructs the output of the output information MO that indicates the result of the determination as to whether or not the target object X is present in the real space image RSI. The processor 19 inputs the input information MI, which includes the generated prompt PT together with the virtual space image VSI and the real space image RSI, to the VLM 50. The processor 19 then acquires the output information MO output from the VLM 50. The processing then proceeds to step S110.

In step S110, the processor 19 determines whether or not the target object X is present in the real space image RSI, based on the acquired output information MO. As a result, when the output information MO indicates that the target object X is not present in the real space image RSI (step S110: No), the processing proceeds to step S112. In addition, as described above, FIGS. 3 and 4 show an example of the virtual space image VSI and the real space image RSI for the same time ti. As shown in FIGS. 3 and 4, the virtual space image VSI and the real space image RSI each include white lines and a crosswalk as common objects. Further, a pedestrian, which is a target object X, is present in the virtual space image VSI. However, this pedestrian is not present in the real space image RSI because the pedestrian is hidden by a building. In addition, the processing of steps S108 and S110 correspond to an example of the “target object determination processing”.

In step S112, the processor 19 determines whether or not the travel assistance TA related to the target object X is necessary. More specifically, the processor 19 determines whether or not a predetermined execution condition A based on the second object information TO2 (e.g., the position and speed of the target object X) regarding the target object X is met. For example, the execution condition A may include that the distance between the target object X and the planned travel route R is less than a predetermined distance. The execution condition A may also include that the target object X approaches the planned travel route R at a speed higher than a predetermined speed. As a result, when the execution condition A of the travel assistance TA is met (step S112: Yes), the processor 19 executes travel assistance processing (movement assistance processing) that assists the travel of the vehicle 2 (step S114).

For example, in the travel assistance processing, the processor 19 executes a notification N to notify the user U of the presence of the target object X via the notification device 15, based on the second object information TO2 related to the detected target object X. As just described, the notification N may be performed to alert the user U to the presence of the target object X. The notification N using the notification device 15 can be performed using, for example, at least one of voice (e.g., “There is a pedestrian ahead to the right”), message (specific examples are the same as above), warning sound, and vibration. The notification N may also include displaying the virtual space image VSI (see FIG. 3, for example) acquired in step S106 on the display 18. The user U to whom the notification N is sent is, for example, a user U who is driving the vehicle 2. Alternatively, the notification N may be sent to a user U who is not driving but is riding in the vehicle 2 being an automated driving vehicle, or may be sent via a remote operation device to a user U who is remotely operating the vehicle 2 from the outside using the remote operation device.

Moreover, the notification N to notify the presence of the target object X may be sent to, instead of the user U, for example, a device (a device mounted on the vehicle 2) that controls the travel device 14 to perform travel control C (movement control) described below. The device is, for example, a travel control electronic control unit (travel control ECU) included in the control device 16. In this example, one or more processors included in the travel control ECU correspond to a part of the one or more processors 19. More specifically, in an example in which the control device 16 includes, together with the travel control ECU, an information processing ECU that executes the virtual image generation processing, the real image acquisition processing, and the target object determination processing, one or more processors of the information processing ECU (corresponding to another part of the one or more processors 19) may execute the notification N to the travel control ECU. This also applies when the vehicle to which the travel assistance system 1 is applied is an automated driving vehicle. In addition, the notification N may be sent to both the user U (notification device 15) and the travel control ECU.

Furthermore, in an example in which the travel control ECU is the target of the notification N, the processor 19 performs the travel control C to avoid a collision between the vehicle 2 and the target object X, based on the second object information TO2 related to the target object X. For example, at least one of brake control for automatically braking the vehicle 2 to avoid a collision and steering control for automatically steering the wheels to avoid a collision corresponds to the travel control C. Further, with regard to this brake control, the processor 19 may, for example, relax an activation start condition of the brake control (i.e., a collision determination condition), which is an example of the above-described execution condition A, as follows, in order to make the brake control easier to activate. That is, when the output information MO indicates that the target object X is not present in the real space image RSI, the processor 19 may relax the activation start condition compared to when the output information MO indicates that the target object X is present in the real space image RSI. This also applies when the vehicle to which the travel assistance system 1 is applied is an automated driving vehicle. Also, in an example in which the user U is the target of the notification N, the processor 19 may perform the travel control C in conjunction with the notification N. After step S114, the processing proceeds to END.

On the other hand, when the execution condition A of the travel assistance TA is not met while the output information MO indicates that the target object X is not present in the real space image RSI (step S112: No), the processing returns to step S106, provided that it is within the prediction target period P. As a result, as described above, at the time ti+1, which is a predetermined time T after the time ti at which the processing of steps S106-S108 is currently executed, the processor 19 executes the processing of steps S106-S110. In addition, when the determination result in step S112 is No, the processing of steps S106-S110 (i.e., the virtual image generation processing, the real image acquisition processing, and the target object determination processing) is repeatedly executed at each predetermined time T during the prediction target period P (in other words, executed in chronological order) until the determination result in step S110 or S112 becomes Yes. In addition, although not shown in FIG. 2, if the time ti exceeds the prediction target period P when the processing proceeds to step S106 after the determination result in step S112 is No, the processing proceeds to END.

On the other hand, when the output information MO indicates that the target object X is present in the real space image RSI (step S110: Yes), the processing proceeds to END. In addition, thereafter, the travel assistance TA based on the first object information TO1 is executed as needed.

### 2-2. Another Example of Processing Flow

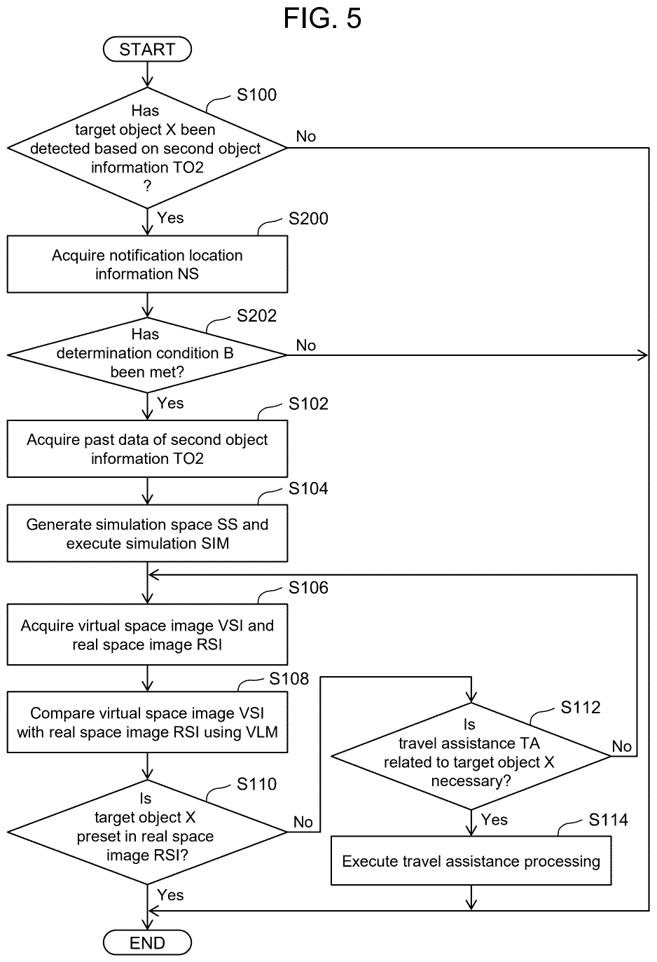

FIG. 5 is a flowchart showing another example of the flow of processing related to the travel assistance TA according to the present embodiment. The processing of this flowchart is different from the processing of the flowchart shown in FIG. 2 in the following points.

In FIG. 5, when the target object X is detected based on the second object information TO2 (step S100: Yes), the processing proceeds to step S200. In step S200, the processor 19 acquires notification location information NS. The notification location information NS is information on a location (notification location) where the notification N in the travel assistance processing was previously performed (i.e., performed in the past). The notification location information NS includes, for example, information indicating the position of the notification location, the date and time of the notification N, and the number of notifications for each notification location. The target of acquisition of the notification location information NS is the above-described notification N to at least one of the user U (notification device 15) and the travel control ECU. The vehicle that is the target of acquisition of the notification location information NS is at least one of the vehicle 2 and one or more other vehicles to which the travel assistance system according to the present disclosure is applied similarly to the vehicle 2. That is, the notification location information NS is acquired by at least one of the vehicle 2 and the one or more other vehicles where the notification N has been made. For example, the acquired notification location information NS may be transmitted to an external system such as the server 40 and collected, or may be shared between vehicles including the vehicle 2 by communicating with each other. In step S200, the processor 19 acquires the notification location information NS thus acquired, from the server 40 or the memory device 20, for example. Then, the processing proceeds to step S202.

In step S202, the processor 19 determines whether or not a determination condition B is met, based on the notification location information NS. The determination condition B is that the location where the target object X is detected based on the second object information TO2 corresponds to a location where the notification N was previously made more than a predetermined number of times or at a frequency equal to or greater than a threshold value. The location where the target object X is detected can be identified from, for example, the position information on the target object X included in the second object information TO2.

When the determination condition B is met (step S202: Yes), that is, when it can be determined that the location where the target object X was detected this time in step S100 is a high-risk location, the processing proceeds to step S102. On the other hand, when the determination condition B is not met (step S202: No), the processing proceeds to END. As described above, according to the processing shown in FIG. 5, the virtual image generation processing, the real image acquisition processing, and the target object determination processing are executed on the condition that the determination condition B is met.

### 2-3. Supplementary Explanation Regarding Execution of Various Kinds of Processing

The various kinds of processing shown in FIGS. 2 and 5 may be executed by one or more processors included in one or more external systems (e.g., pedestrian recognition system 30, server 40) that wirelessly communicate with the vehicle 2, instead of or in addition to the one or more processors 19 included in the in-vehicle system 10. Specifically, for example, at least one of the virtual image generation processing, the real image acquisition processing, and the target object determination processing may be executed by the server 40 or by cooperation between the server 40 and the pedestrian recognition system 30. Furthermore, for example, the travel assistance processing may be executed by the server 40 or by cooperation between the server 40 and the in-vehicle system 10. For example, the server 40 may instruct the in-vehicle system 10 to execute at least one of the notification N and the travel control C.

### 3. Effect

As described above, according to the present embodiment, when the target object X is detected based on the second object information TO2 acquired using the second sensor (e.g., monitoring camera 32) that is not equipped with the vehicle 2, the virtual image generation processing, the real image acquisition processing, and the target object determination processing are executed. That is, a virtual space image VSI representing the result of the prediction of the state of the target object X is generated based on the second object information TO2. Also, a real space image RSI is acquired based on the image information I acquired using the first sensor (e.g., recognition sensor 17) equipped with the vehicle 2 at a timing synchronized with the time t of the virtual space image VSI. Then, the virtual space image VSI and the real space image RSI are compared by the VLM 50, and the output information MO indicating the result of the determination as to whether or not the target object X is present in the real space image RSI is output from the VLM 50. This makes it possible to properly recognize the target object X that is not detected by the first sensor but is detected by the second sensor. In addition, by generating a virtual space image VSI as the prediction information indicating the result of the prediction of the state of the target object X, the above-described comparison becomes possible using the VLM 50, which is a multimodal generative AI model.

Moreover, according to the present embodiment, when a determination result indicating that the target object X is not present in the real space image RSI is acquired from the VLM 50, the travel assistance processing may be executed on the condition that the above-described execution condition A is met. This makes it possible to perform the travel assistance TA as needed by utilizing the information on the target object X that is not detected by the first sensor but is detected by the second sensor. More specifically, the travel assistance TA regarding a target object X that has not been detected at least at a point in time when the above-described determination result is acquired can be started early (i.e., at a timing that cannot be achieved by only the first object information TO1 based on the first sensor). Further, the travel assistance TA regarding a target object X that cannot ultimately be detected by the first sensor can be performed.

Moreover, according to the present embodiment, when the execution condition A is not met while the output information MO indicates that the target object X is not present in the real space image RSI (step S112: No), the virtual image generation processing, the real image acquisition processing, and the target object determination processing may be repeatedly executed at each predetermined time T during the prediction target period P until the output information MO indicates that the target object X is present in the real space image RSI (step S110: Yes) or the execution condition A is met (step S112: Yes). In addition, when the output information MO indicates that the target object X is present in the real space image RSI, the same target object X can also be acquired from the first object information TO1. Therefore, by repeatedly executing the three kinds of processing as described above at each predetermined time T, appropriate travel assistance TA can be quickly performed with also taking into consideration the acquisition status of the first object information TO1, which may change from moment to moment.

Moreover, the travel assistance processing according to the present embodiment may also include executing the notification N. This makes it possible to inform the user U in advance of information on the target object X that has not been detected by the first sensor but has been detected by the second sensor, i.e., information that requires attention on the planned route R of the vehicle 2.

Moreover, the notification N according to the present embodiment may include displaying the virtual space image VSI on the display 18. This allows the user U to be notified of information on the target object X in an easy-to-understand manner.

The travel assistance processing according to the present embodiment may also include executing the travel control C. This allows the vehicle 2 to travel safely while taking into consideration the target object X that is not detected by the first sensor but is detected by the second sensor. In addition, in an example in which the notification N is sent to the user U in conjunction with the travel control C, the notification N can also be used to inform the user U of the reason why the travel control C was activated.

Moreover, according to the present embodiment, it may be determined based on the notification location information NS whether or not the determination condition B is met, that is, whether the location where the target object X is detected based on the second object information TO2 corresponds to a location where the notification N was previously made more than a predetermined number of times or at a frequency equal to or greater than a threshold value. Then, the virtual image generation processing, the real image acquisition processing, and the target determination processing may be executed on the condition that determination condition B is met. In other words, these three kinds of processing may be performed only in locations where there is a high risk regarding the safe driving of the vehicle 2. This makes it possible to effectively recognize the target object X while reducing the processing load on the processor 19.

Furthermore, according to the present embodiment, the virtual space image VSI may be generated based on the traffic situation information TS together with the second object information TO2. This makes it possible to acquire a more appropriate prediction result of the state of the target object X while also taking into consideration the traffic situations around the vehicle 2.

What is claimed is:

1. A movement assistance system for assisting movement of a moving body, the movement assistance system comprising:
one or more first sensors equipped with the moving body;
one or more second sensors included in one or more external systems that perform wireless communication with the moving body; and
processing circuitry configured to:
acquire first object information and image information around the moving body using the one or more first sensors;
acquire second object information around the moving body using the one or more second sensors; and
when detecting a target object based on the second object information, execute virtual image generation processing, real image acquisition processing, and target object determination processing, wherein
the virtual image generation processing includes generating a virtual space image that represents a result of prediction of a state of the target object, based on the second object information,
the real image acquisition processing includes acquiring a real space image that is based on the image information acquired at a timing synchronized with time of the virtual space image, and
the target object determination processing includes:
inputting, to a multimodal generative AI model, input information including the virtual space image, the real space image, and a prompt that instructs an output of output information indicating a result of determination as to whether or not the target object is present in the real space image; and
causing the multimodal generative AI model to output the output information.

2. The movement assistance system according to claim 1, wherein
the processing circuitry is further configured to, when the output information indicates that the target object is not present in the real space image, execute movement assistance processing of assisting the movement of the moving body, provided that an execution condition based on the second object information on the target object is met.

3. The movement assistance system according to claim 2, wherein
the processing circuitry is further configured to, when the execution condition is not met while the output information indicates that the target object is not present in the real space image, execute the virtual image generation processing, the real image acquisition processing, and the target object determination processing at each predetermined time during a target period of the prediction until the output information indicates that the target object is present in the real space image or the execution condition is met.

4. The movement assistance system according to claim 2, further comprising a notification device configured to notify a user of the moving body of information, wherein
the movement assistance processing includes executing a notification to notify the user of a presence of the target object via the notification device.

5. The movement assistance system according to claim 4, wherein
the notification device includes a display, and
the notification includes displaying the virtual space image on the display.

6. The movement assistance system according to claim 2, wherein
the movement assistance processing includes executing movement control of the moving body to avoid a collision between the moving body and the target object based on the second object information on the target object.

7. The movement assistance system according to claim 2, wherein
the processing circuitry is further configured, when detecting the target object based on the second object information, to:
acquire notification location information on a notification location where a notification was previously made to notify a presence of the target object when the output information indicates that the target object is not present in the real space image;
determine, based on the notification location information, whether or not a determination condition is met, wherein the determination condition is that a location where the target object is detected based on the second object information corresponds to a location where the notification was previously made more than a predetermined number of times or at a frequency equal to or greater than a threshold value; and
execute the virtual image generation processing, the real image acquisition processing, and the target object determination processing, provided that the determination condition is met.

8. The movement assistance system according to claim 1, wherein
in the virtual image generation processing, the processing circuitry is further configured to generate the virtual space image based on traffic situation information indicating a traffic situation around the detected target object, together with the second object information.

9. A movement assistance method executed by a computer to assist movement of a moving body, the movement assistance method comprising:
acquiring first object information and image information around the moving body using one or more first sensors equipped with the moving body;
acquiring second object information around the moving body using one or more second sensors included in one or more external systems that perform wireless communication with the moving body; and
when detecting a target object based on the second object information, executing virtual image generation processing, real image acquisition processing, and target object determination processing, wherein
the virtual image generation processing includes generating a virtual space image that represents a result of prediction of a state of the target object, based on the second object information,
the real image acquisition processing includes acquiring a real space image that is based on the image information acquired at a timing synchronized with time of the virtual space image, and
the target object determination processing includes:
inputting, to a multimodal generative AI model, input information including the virtual space image, the real space image, and a prompt that instructs an output of output information indicating a result of determination as to whether or not the target object is present in the real space image; and
causing the multimodal generative AI model to output the output information.

10. A non-transitory computer-readable recording medium storing a movement assistance program executed by a computer to assist movement of a moving body,
the movement assistance program causing the computer to execute:
acquiring first object information and image information around the moving body using one or more first sensors equipped with the moving body;
acquiring second object information around the moving body using one or more second sensors included in one or more external systems that perform wireless communication with the moving body; and
when detecting a target object based on the second object information, executing virtual image generation processing, real image acquisition processing, and target object determination processing, wherein
the virtual image generation processing includes generating a virtual space image that represents a result of prediction of a state of the target object, based on the second object information,
the real image acquisition processing includes acquiring a real space image that is based on the image information acquired at a timing synchronized with time of the virtual space image, and
the target object determination processing includes:
inputting, to a multimodal generative AI model, input information including the virtual space image, the real space image, and a prompt that instructs an output of output information indicating a result of determination as to whether or not the target object is present in the real space image; and
causing the multimodal generative AI model to output the output information.
